(19) United States
(12) Patent Application Publication
(10) Pub. No.: US 2025/0278630 A1
(43) Pub. Date: Sep. 4, 2025

(54) PROMPT GENERATION WITH EVOLUTIONARY OPERATORS

(71) Applicant: Intuit, Inc., Mountain View, CA (US)

(72) Inventors: Yair Horesh, Kfar-Saba (IL); Guy Shtar, Ness Ziona (IL)

(21) Appl. No.: 18/591,045

(22) Filed: Feb. 29, 2024

(51) Int. Cl. G06N 3/0895

(52) U.S. Cl. CPC G06N 3/0895

(57) ABSTRACT

Certain aspects of the disclosure pertain to prompt creation using language models in an evolutionary algorithm framework. A language model can be employed to generate an initial set of candidate prompts that return responsive replies to legitimate questions and disapproval replies to illegitimate questions. Candidate prompts can be scored. Subsequently, two or more candidates can be selected based on their scores. Additionally, candidate prompts can be generated with a language model by applying evolutionary operations to the two or more candidate prompts. Scores can be generated for the additional candidate prompts, and a termination criterion is evaluated to determine whether another iteration should be performed. After the termination criterion is satisfied, one or more candidate prompts can be output based on their score.

### BACKGROUND

### Field

Aspects of the subject disclosure relate to artificial intelligence and, more specifically, to automated prompt engineering for large language models.

### Description of Related Art

Artificial Intelligence (AI) has experienced significant advances in natural language processing (NLP) propelled by the evolution of large language models (LLMs), such as Generative Pre-trained Transformer (GPT) series models. These transformer-based models have gained prominence due to their ability to seemingly comprehend and generate human-like text. Transformer-based models undergo extensive pre-training on vast textual data and employ deep learning techniques and neural networks to process and generate text based on input received.

Prompts serve as guiding instructions to direct an LLM's comprehension and response generation processes. Prompts can vary in complexity, ranging from a simple sentence structure to more intricate and detailed cues designed to steer a model, such as an LLM, to generate coherent and contextually relevant responses. Crafting effective prompts involves using specific words or phrases and formatting input to guide a model toward producing a desired output. Designing an effective prompt (e.g., one that generates a useful model output) is a manual process that can take a significant amount of time and for which there is little predictability.

### SUMMARY

According to one aspect, a method of prompt generation is disclosed. The method comprises receiving an initial set of candidate prompts from a large language model in response to a request, generating a score for each candidate prompt in the initial set of candidate prompts, repeating until a termination criterion is satisfied the following: selecting two or more candidate prompts based on the score, creating additional candidate prompts with the large language model by applying evolutionary operators to the two or more candidate prompts, generating the score for the additional candidate prompts, and evaluating the termination criterion, outputting one or more candidate prompts based on the score.

According to another aspect, a method is disclosed that comprises submitting a set of one or more legitimate questions and answers and a set of illegitimate questions and a single answer associated with a request to a large language model, receiving, in response to the request, an initial set of candidate prompts from a large language model that returns a response to the set of legitimate questions and disapproval of the set of illegitimate questions, generating a score for each candidate prompt in the initial set of candidate prompts. The method further comprises repeating the following until a termination criterion is satisfied: selecting two or more candidate prompts based on the score, creating additional candidate prompts with the large language model by applying one or more evolutionary operators to the two or more candidate prompts, generating the score for the additional candidate prompts, and evaluating the termination criterion. One or more candidate prompts can be subsequently output based on the score. Other aspects provide processing systems configured to perform the aforementioned methods as well as those described herein; non-transitory, computer-readable media comprising instructions that, when executed by a processor of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects of this disclosure.

### DESCRIPTION OF THE DRAWINGS

The appended figures depict certain aspects and are, therefore, not to be considered limiting of the scope of this disclosure.

FIG. 1 is a block diagram of a high-level overview of an example implementation of prompt generation.

FIG. 2 is a block diagram of an example prompt system.

FIG. 3 is a flow chart diagram of an example prompt generation component.

FIG. 4 is a flow chart diagram of an example method of prompt generation.

FIG. 5 is a block diagram of an operating environment within which aspects of the subject disclosure can be performed.

To facilitate understanding, identical reference numerals have been used, where possible, to designate identical elements common to the drawings. It is contemplated that elements and features of one embodiment may be beneficially incorporated in other embodiments without further recitation.

### DETAILED DESCRIPTION

Aspects of the subject disclosure provide apparatuses, methods, processing systems, and computer-readable mediums for automated prompt generation to refine output generation of an LLM, utilizing at least one other LLM and one or more evolutionary algorithms. Determining an effective prompt is an important technical step for generating a desired output from an LLM. Further, an effective prompt has the beneficial technical effect of reducing the occurrence of irrelevant and potentially harmful results produced by an LLM.

Conventionally, manual prompt engineering can be employed to guide output generation by LLMs. Manual prompt engineering refers to engineers or users manually specifying instructions to guide an LLM to produce desired outputs. The manual specification process is an iterative and experimental approach that involves trial, error, and adjustment with respect to the wording, structure, and context of a prompt until an LLM achieves the desired results.

However, there are several technical problems with the conventional manual approach. First, it is difficult, if not impossible or impracticable, for a human to write a prompt that matches many desired criteria, capturing nuances and edge cases of complex domains. Consider a tax domain and an input query regarding tax deductions for business expenses. It would be challenging to generate a prompt that accounts for complexities related to specific business contexts (e.g., freelancer, small business, and large corporation), changing laws, individual tax situations, regional variances, and the interplay between different deductions and tax elements. Consequently, LLM output may be inaccurate or nonsensical. Second, manually written prompts may not generalize well beyond the exact questions and scenarios tested. Stated differently, manual prompts may not perform well on new unseen questions and scenarios, as humans may have limitations in contemplating a vast and complex space of possible prompts, potentially failing to consider effective variations and combinations. Third, manual prompts can include biases and subjectivities of a human author, which can lead to biased or opinionated responses. Further, whether or not a prompt performs well or poorly is a subjective opinion that varies from person to person and levels of expertise. As a result, further resources may be utilized unnecessarily to iteratively refine a prompt.

Aspects described herein provide a technical solution to at least the aforementioned technical problems. Specifically, methods for automated prompt engineering utilizing machine learning and evolutionary operators are described herein to improve prompt generation for LLMs. In one instance, a prompt can be generated that enhances output generation by discriminating between queries that are responded to with information that addresses the queries and queries that are not. In this manner, issues associated with capturing the complexity of particular domains, such as inaccurate responses, can be avoided, and resource utilization can be improved. For example, rather than attempting to respond with tax information requested, the response can direct a user to seek advice from a tax professional. Further, an objective scoring mechanism can be provided to measure prompt performance in terms of one or more metrics (e.g., accuracy of response, cost in terms of prompt length, safety, and security), reducing or eliminating reliance on subjective opinion. Candidate prompts can be generated with evolutionary algorithms inspired by biological evolution, specifically natural selection. The fittest candidate prompts can be identified based on a score produced by the scoring mechanism. Subsequently, evolutionary operators, such as crossover and mutation, can be utilized to produce a new generation of prompts, for example, from the fittest candidate prompts. Additional generations of prompts can be iteratively produced to maximize prompt performance in terms of score. This replaces a manual approach that relies on trial and error as well as intuition or subjective opinion regarding prompt performance. As a result, prompt generation can be more efficient, especially when dealing with complex and diverse domains, as a broad range of prompt variations can be determined and evaluated quickly. Further, utilizing evolutionary operators, prompt variations and combinations that may not be apparent to a human author can be explored.

In one example, as described further herein, a first machine learning model can generate an initial set of candidate prompts based on legitimate and illegitimate questions and answers. A legitimate question can have a corresponding answer that addresses the question, and an illegitimate question can return an indication that the question cannot or will not be answered. In this manner, the initial set of candidate prompts can discriminate between legitimate and illegitimate questions and answers, increasing response time for some input (e.g., illegitimate questions) and increasing computing resource availability for other input (e.g., legitimate questions). A scoring function or model can be applied to the initial set of candidate prompts to generate a score that describes how well an LLM answers questions with a prompt, among other things. A subset of one or more candidate prompts can be identified based on score. At least one evolutionary or genetic operator can be applied to the subset of one or more candidate prompts. Evolutionary or generic operators refer to mechanisms inspired by biological evolution and natural selection that generate successive generations of prompts favoring prompts with high-performance scores for propagation. For example, crossover, mutation, or both can be utilized to generate a new generation of prompts, which can be evaluated, scored, and either kept or discarded. The evolutionary operators enable efficient evaluation of a vast and complex space of possible prompts in an iterative manner, successively identifying higher-performing prompts based on the score returned by the scoring function or model.

### Example Implementation of Prompt Generation

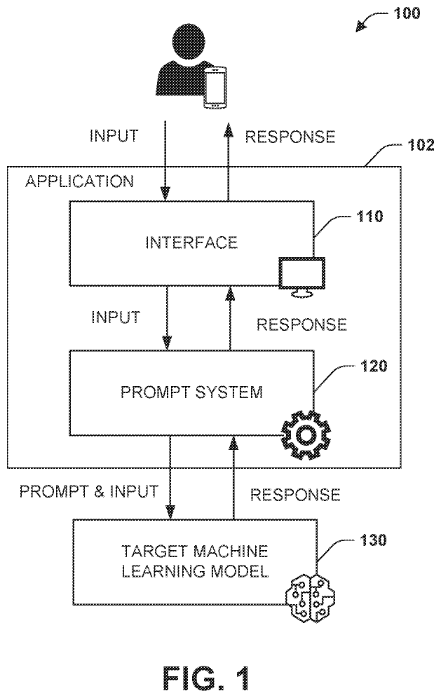

FIG. 1 depicts a high-level overview of an example implementation 100 of aspects associated with prompt generation. In accordance with one embodiment, the implementation 100 produces hard prompts. Hard prompts are human-readable text prompts that guide a machine learning model, such as an LLM, to generate an appropriate and contextually relevant response without refining or changing the LLM. Unless noted otherwise, automated prompt generation described herein corresponds to hard prompts.

The implementation 100 includes application 102, interface 110, prompt system 120, and target machine learning model 130. A user can utilize the interface 110 to interact with the target machine learning model 130 through the application 102. The prompt system 120 can intercept input from the interface 110 and insert a generated prompt with the input before transmission to the target machine learning model 130. The prompt system 120 can also receive a response from the target machine learning model 130 and transmit the response back to the interface 110. Alternatively, the response can be provided directly to the interface 110.

The application 102 is a software application that includes at least a subset of components designed to interact with the target machine learning model 130. In one instance, the application can correspond to a financial transaction management application or an income tax return application, among other things. The application 102 may employ generative artificial intelligence in the form of an LLM to assist users. For example, the application 103 can be or include an intelligent agent or chatbot that helps users by responding to questions. In the income tax return context, the assistance can correspond to explaining all or aspects of a tax return. To implement such functionality, the application 102 can interact with the target machine-learning model 130, embodied as an LLM, by transmitting user input to the target machine learning model 130 and receiving and displaying a response from the target machine-learning model 130.

The interface 110 is configured as a user interface to enable user interaction through a user computing device with the application 102. The user interaction can correspond to specifying input, for example, as part of an input prompt, receiving a response to the input. In one instance, the interface 110 can correspond to a web-based interface that users can access through a web browser. The interface 110 can include an input section and an output section. For example, a text input box can allow users to input questions or instructions, and a text output box can display generated text or responses. The interface 110 can optionally display a history section that shows past transactions and a feedback mechanism for optionally providing feedback on the output.

The prompt system 120 is configured to automatically generate a prompt to be added to the input to adjust the target machine learning model 130 output for a particular situation. For example, if the application 102 is an income tax application with a chatbot, prompts can be specified to guide the target machine learning model 130 to output appropriate and accessible responses given the tax domain. Further, prompts can correct vulnerabilities associated with LLMs that allow a hacker to control the model's output. In other words, strong or secure prompts can be generated that are less vulnerable to adversarial attacks than weak or insecure prompts. In accordance with one embodiment, prompts can include one or more segments that are predefined sub-texts of the prompt that cover a specific subject. Examples include task definition, expected input/output, guardrails, and user context.

As described in further detail hereinafter, the prompts can be generated utilizing a combination of generative machine learning models, such as large language models and evolutionary operators. In accordance with one embodiment, a plurality of questions and answers can be specified and utilized as a basis for generating an initial set of candidate prompts utilizing a generative machine learning model. In one instance, the questions, answers, or both can be automatically generated and potentially saved and reused. For example, an LLM can be trained to generate relevant questions in the context of the application 102 and generate malicious prompts.

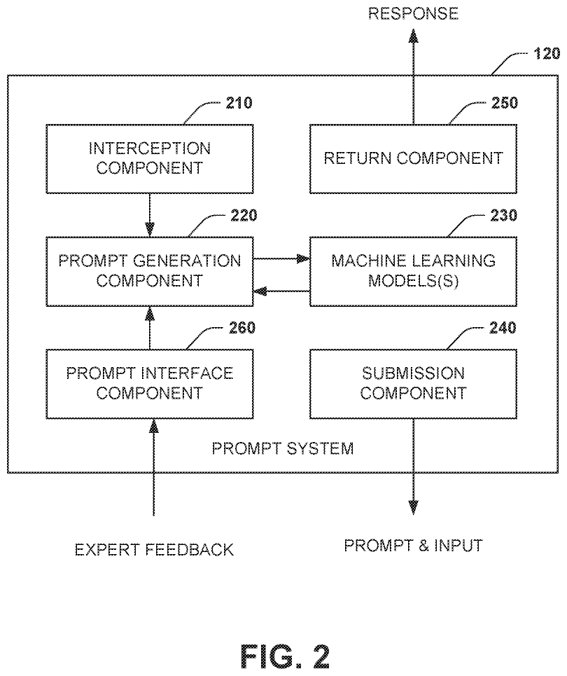

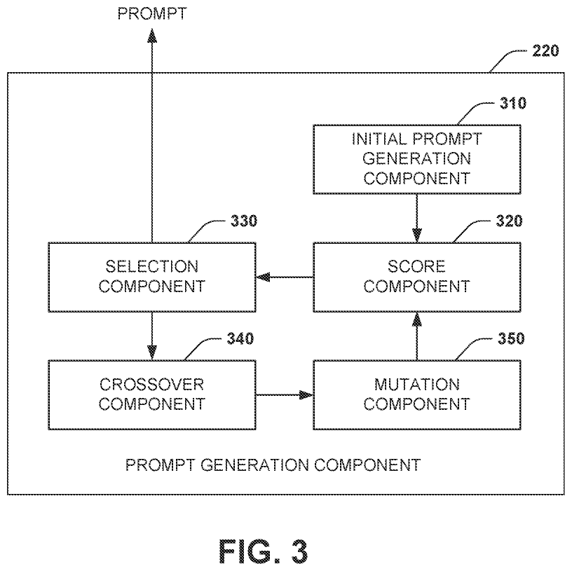

The candidate prompts can be scored based on various criteria (e.g., execution time, response relevancy, accuracy, response clarity, and prompt length), and one or more prompts can be selected based on the score. In one instance, a machine learning model can score a prompt based on how well a target model responds. In one instance, performance can be measured with respect to how well a target model responds to input similar to a legitimate question or an illegitimate question. In one embodiment, performance can be determined by comparing generated output to expected output. In another embodiment, an LLM can be presented with generated output and asked to measure performance. The score can reflect whether the target model indicates that it will not respond to an illegitimate question. Subsequently, evolutionary algorithms, including genetic operators (e.g., mutation, crossover), can be utilized to generate additional prompts, for example, based on crossover, mutation, or both, further described with respect to FIGS. 2 and 3. The additional prompts can be candidate prompts that can be scored and further processed until a termination criterion is satisfied or reached (e.g., time, number iterations, score). One of the candidate prompts can be selected, combined with user input, and transmitted to the target machine-learning model 130.

The target machine learning model 130 corresponds to a large language model (LLM), such as a generative pre-trained transformer (GPT) series of models. The target machine learning model 130 can be a computational model that learns patterns and representations from data to make predictions or generate new content for tasks like text completion, translation, summarization, and conversation. The target machine learning model 130 is targeted for processing user input. Other machine learning models described herein can be employed to generate and optionally evaluate prompts that accompany the user input destined for the target machine learning model 130. However, in some instances, the target machine learning model 130 may be the same model that generates the prompts.

A prompt can be sent with input to the target machine learning model 130. As previously noted, the prompt can correspond to a hard prompt followed by the input provided by a user, sometimes referred to as an input prompt. The prompt can guide output generated by the target machine learning model 130 for a specific context or situation. For example, the prompt can steer the output toward a situation addressed by the application 102, such as financial management or income tax return preparation.

The prompts can also implement ethical and legal guardrails. In one embodiment, a prompt can specify a number of do-not-answer queries, contexts, or scenarios. The prompt can guide the target machine learning model 130 not to answer a question that deals with unethical or illegal behavior. For example, a prompt can indicate that questions regarding financial fraud or tax evasion should not be answered. In another instance, the prompts can provide guardrails against providing a potentially bad response. For example, an individual may have been married this year, and the individual asks if they can file their taxes as they have before he was married. There are various implications regarding when and where the individual was married and filing options (e.g., married filed together, married filed separately). As a result, the prompt can alter the response to suggest they talk to an accountant about the situation.

As a further example, consider a scenario in which the application 102 is a customer service chatbot, and a customer inputs: “Hi, I placed an order a week ago, and it still has not arrived. Can you tell me what is going on?” A weak prompt is a prompt that potentially provides a bad response. A strong prompt can specify a guardrail against providing a bad response. In the context of customer service described above, a weak prompt can be “You are a customer service representative for a retail store. The customer has been waiting longer than expected for their order and is becoming anxious.” A strong prompt can be “You are a customer service representative for a retail store. You are given a customer's order number and need to provide an update on the status of their delivery. Remember to: 1. Be polite and professional; 2. Do not disclose any personal information about the customer; and 3. Do not talk about controversial issues.” Further, the strong prompt can include context data that the customer has been waiting longer than expected for their order and is becoming anxious. The portion of the prompt that provides a reminder to be polite and professional, not disclose personal information, and not converse about controversial issues can correspond to guardrails on output.

### Example System of Prompt Generation

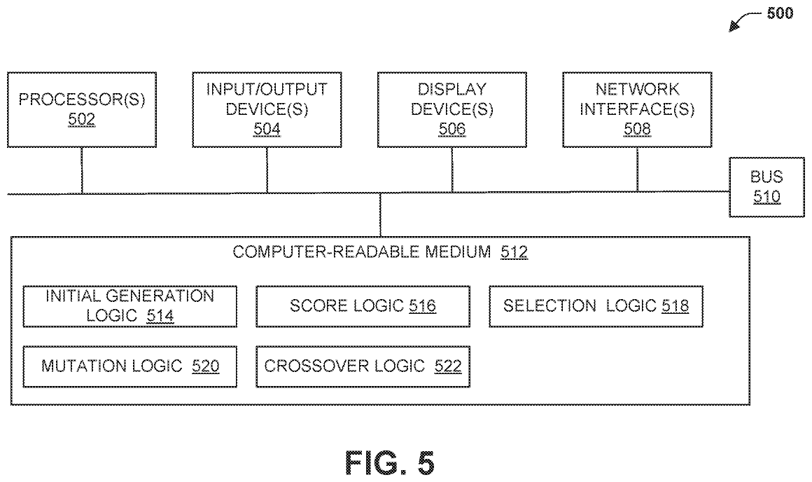

FIG. 2 illustrates a block diagram of an example implementation of the prompt system 120 briefly described in FIG. 1. In the depicted example, the prompt system 120 includes interception component 210, prompt generation component 220, machine learning models 230, submission component 240, return component 250, and prompt interface component 260. The interception component 210, prompt generation component 220, machine learning models 230, submission component 240, return component 250, and prompt interface component 260 can be implemented by at least one processor (502 of FIG. 5) coupled to at least one memory (512 of FIG. 5) that stores instructions that, when executed by the at least one processor, cause the processor to perform the functionality of each component when executed. Consequently, a computing device can be configured as a special-purpose device or appliance that implements the functionality of the prompt system 120. Further, all or portions of the prompt system 120 can be distributed across computing devices or made accessible through a network service.

The interception component 210 is configured to intercept input transmitted to a target machine learning model such as an LLM. The interception component 210 is positioned between the interface 110 and the target machine learning model 130. In a web implementation, for example, the interception component 210 can intercept a hypertext transfer protocol (HTTP) request before it reaches the target machine learning model 130. The intercepted request can be transmitted or otherwise made available to the prompt generation component 220, the submission component 240, or both.

The prompt generation component 220 is configured to generate a hard prompt for submission with an intercepted user-provided input. The input can take the form of an input prompt that comprises instructions or questions, among other input types. A generated hard prompt is a human comprehendible text prompt configured to refine the output of the target machine learning model. In accordance with one embodiment, one or more machine learning models 230 can be utilized to generate the hard prompt. In other words, generative artificial intelligence can be employed to produce prompts that control the output of another model, such as an LLM. For example, an LLM can be utilized to generate an initial set of prompts for consideration based on provided questions and answers.

The one or more machine learning models 230 can be trained based on historical data including a corpus of training data associated with prompts and the effects of such prompts on the output of a target machine learning model 130. In one embodiment, a machine learning model can be trained utilizing a knowledge base of best practices (e.g., standards and recommendations) and examples of weak and strong prompts demonstrating input and output. Different machine learning models 230 can be paired with different target machine learning models 130 (e.g., GPT, Gemini, Llama) or versions (e.g., GPT 3, 3.5, 4) to adapt to differences. Further, different machine learning models 230 can be associated with different contexts or concerns, such as producing an initial candidate set of prompts and scoring and selecting prompts for further processing or output. The prompt generation component 220 can analyze an intercepted request to identify the target machine learning model 130 in one embodiment. For example, the intercepted request can indicate a target LLM or version thereof, which can be utilized to identify an appropriate machine learning model. Further, the prompt generation component 220 can analyze the request to determine context or concerns, which can then be utilized to select one or more machine learning models 230.

Turning briefly to FIG. 3, an example prompt generation component 220 is illustrated in further detail. As shown, the prompt generation component 220 includes an initial prompt generation component 310, score component 320, selection component 330, crossover component 340, and mutation component 350, which can be implemented by at least one processor coupled to at least one memory that stores instructions that, when executed by the at least one processor, cause the processor to perform the functionality of each component when executed. Furthermore, at least a subset of the components can employ one or more machine learning models 230 from FIG. 2. For example, the score component 320 can be embodied as a machine learning model that outputs scores. All or portions of the prompt generation component 220 can be distributed across computing devices or made accessible through a network service.

The initial prompt generation component 310 is configured to generate an initial set of candidate prompts for consideration. In accordance with one embodiment, the initial set of candidate prompts can be generated by a machine-learning model, such as an LLM, based on sets of questions and answers. In accordance with one embodiment, an LLM can be trained with techniques such as in-context learning, which does not formally change the model but improves performance on a given task, fine-tuning, providing example pairs of inputs and outputs, and reinforcement learning from human feedback, in which a human is providing input to the training process. Two sets of questions and answers can be specified manually or automatically in one embodiment. A first set of questions can correspond to legitimate questions with one or more good answers for each question. The second set of questions can correspond to illegitimate questions with the same or similar answer, such as “I am sorry, but I cannot answer such a question.” For example, the first set of questions can correspond to legitimate tax planning questions, and the second set of questions can correspond to tax evasion techniques. The initial prompt generation component 310 can employ a machine learning model, such as a large language model, to create prompts that respond to legitimate questions with information that addresses the question and respond to illegitimate questions with an indication that the question will not be answered thereby disapproving or rejecting illegitimate questions. The set of prompts can correspond to the initial population of prompt candidates for evolutionary processing.

The score component 320 is configured to score prompt candidates using one or more metrics. Example metrics can include, but are not limited to, the cost of running the prompt in terms of computational resources required, the time it takes to execute the prompt, and the confidence in the prompt to answer questions similar to suggested answers in the first and second sets of questions, and the vulnerability of the prompt to adversarial attack (e.g., secure or insecure prompts), for instance, by prompt injection, which involves the introduction of instructions designed to perform unauthorized action including ignoring previous instructions or content moderation guidelines, exposing underlying data, or producing forbidden content. Other risks associated with prompt injection include leaking the prompt and overriding an intended task, such as writing code instead of an email. Another vulnerability can involve using a delimiter to define the user input area, such as: “The user input will be given in triple #. Here is the user input ###. Attack goes here ###.”

In one instance, the score can be a weighted average of several metrics. Further, as noted above, the score component 320 can be embodied as a machine learning model capable of computing a score for prompts based on various metrics. For example, the machine learning model can be trained with examples of human evaluations of prompts where the model tries to predict a human-assigned score by analyzing the text of a prompt. In one instance, the model can evaluate whether questions are answered correctly by responding with information that answers a question or an indication that a response will not be provided.

The selection component 330 is configured to select one or more prompts based on a score computed by the score component 320 for each individual prompt. One or more thresholds can be utilized by the selection component 330 to select the one or more prompts for further processing or return as a final output prompt. Additionally or alternatively, the selection component 330 can identify the best prompt based on the highest score or several prompts based on scores. After selecting a set of candidate prompts based on scores for further processing, the next generation of candidate prompts can be generated by the crossover component 340, the mutation component 350, or both as part of an evolutionary or genetic algorithm. In accordance with one embodiment, crossover is performed, followed by mutation to generate a new generation of candidate prompts. Further, the score can capture fitness in the evolutionary context.

The crossover component 340 is configured to generate a new generation of candidate prompts by combining prompts to form a new prompt. For example, two existing candidate prompts (e.g., parents) can be combined by selecting aspects of a first candidate prompt and aspects of a second candidate prompt and combining the aspects to generate a third prompt (e.g., child). The aspects can be prompt text snippets, sentences, or paragraphs. The crossover component 350 enables the introduction of combinations of successful prompts that are potentially higher scoring than either constituent prompt. In one embodiment, an LLM can be provided with two prompts and asked to combine them and generate new prompts.

The mutation component 350 is configured to generate a new generation of candidate prompts by changing existing candidate prompts. The mutation component 340 generates a mutated version of an existing candidate prompt by changing a small random change to the candidate prompt, such as a child prompt produced by combining aspects of two parent prompts in crossover. Such a change can include but is not limited to adding or removing text, rephrasing a sentence, changing the order of sentences, changing the order of sections, or adding a new sentence. The mutation component 350 can be constrained by particular rules, such as modifying a certain part of a prompt or keeping prompt length within bounds. The mutated version of an existing candidate prompt can be added to a current set of prompt candidates. The mutation component 350 enables exploration of new prompts around high-scoring prompts to produce even higher-performing prompts. In one embodiment, a model can be asked to rank the best next action from removing text, adding an instruction, or adding a delimiter. Next, a generative model can execute the action to produce a new generation.

A termination criterion or condition can halt the evolutionary process and return a prompt from the prompt candidates. The termination criterion can correspond to an amount of time, number of generations, or a prompt score satisfying a threshold, among other things.

Genetic algorithms, including crossover and mutation operations, are optimization techniques inspired by natural selection and evolution. Employment of genetic algorithms, as disclosed herein, enables exploring a large and diverse space of potential prompts and converging to an optimal prompt. Genetic algorithms automate optimization by iteratively applying selection, crossover, and mutation to converge toward a global optima or near-optimal prompt.

Returning to FIG. 2, the prompt provided by the prompt generation component 220 can be provided to the submission component 240 for transfer with an initial query or request to the target machine learning model 130 of FIG. 1. The prompt system 120 can receive the response from the target machine learning model 130, and forward the response back to the interface through the return component 250.

The prompt interface component 260 is configured to enable human intervention in the prompt generation process. In accordance with one embodiment, an expert can write an initial prompt, which can be scored and utilized as a basis for generating other potentially higher-scoring prompts. Additionally or alternatively, human-in-the-loop reinforcement learning or reinforcement learning from human feedback can be employed to enable corrective action. For example, the score component 320 can be a model that can be retrained or fine-tuned based on expert feedback regarding scoring. According to yet another aspect, the prompt interface component 260 can enable human intervention to select the output prompt from a set of two or more prompts. In accordance with one embodiment, the reinforcement learning from human feedback can be employed to improve the prompt generation component 220. Further, the prompt interface enables alternating between a human and a model that generates prompts, wherein the model can be updated based on a difference between a prompt generated manually by a user and a prompt generated by the model. Furthermore, a human can employ the prompt interface component 260 to provide text instructions recommending or suggesting a change.

### Example Methods of Prompt Generation

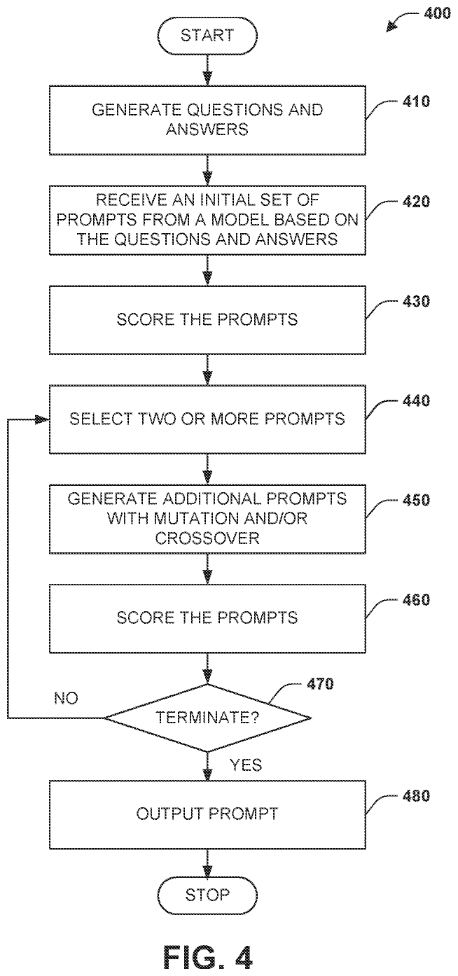

FIG. 4 depicts an example method 400 of prompt generation utilizing evolutionary algorithms. In one aspect, method 400 can be implemented by the prompt system 120 of FIGS. 1 and 2. To facilitate clarity and understanding, the example method 400 is described with respect to an email writing application.

Method 400 starts at block 410 with generating questions and answers. Question and answer generation can be performed manually (e.g., human performed without the aid of automated tools or assistance), semi-automatically (e.g., a combination of human intervention with the aid of automated tools or assistance), or automatically (e.g., entirely automatic without human intervention). In one embodiment, two sets of questions and answers can be specified. The first set of questions can be legitimate questions with corresponding correct answers. The second set of questions can be illegitimate questions with the same or similar answer, indicating an inability to respond. The legitimate questions and answers are used to guide responses to similar answers. The illegitimate questions can be utilized to avoid undesirable responses. The questions and answers can be used to seed generation of an initial set or generation of candidate prompts, such as in an evolutionary computation process. Even if the questions are manually specified, the input required from a human user is limited. In the context of an email writing application, the questions and answers can be specified to aid in defining valid inputs or, in other words, valid emails to respond to.

Method 400 then proceeds to block 420 with receiving an initial set of candidate prompts from a model based on the questions and answers. In accordance with one embodiment, a large language model can be trained to generate prompts based on questions and answers. For example, the large language model can be given a task and a set of best practices to write prompts and asked to generate 10 prompts based on the input. The large language model can be invoked with the questions and answers generated in block 410 and returns a set of initial candidate prompts in response. The large language model can produce a set of initial candidate prompts that can discriminate between legitimate questions to be answered and illegitimate questions not to be answered. Consequently, issues associated with capturing the complexity of particular domains, such as inaccurate responses, can be avoided, and resource utilization can be improved by directing resources to respond to legitimate questions. Based on the questions, an initial set of candidate prompts associated with email generation, for example, “You are an email answering bot,” “Answer any given email,” and “Here is an email to respond to:”

Method 400 continues next to block 430, with scoring the initial candidate prompts. The score can be determined based on one or more metrics associated with a candidate prompt. The metrics can include but are not limited to accuracy, coverage, diversity, length, runtime, and adherence to criteria. Accuracy can measure how accurately a language model answers legitimate questions with a prompt. Coverage can measure how well a prompt enables responses to a wide range of questions. Diversity can measure the variety of responses generated for a given question. Length and runtime measure how many characters the prompt comprises and how long it takes to execute. Adherence to criteria measures how well it avoids responses to illegitimate questions. The score can be an objective rather than a subjective measure of a prompt's quality, performance, or fitness. Further, the score can be computed by an evolutionary fitness function that quantifies how well a candidate prompt is predicted to perform, wherein prompts with higher scores are considered better. In one instance, each example email writing prompt can be scored on a set of predefined questions regarding metrics.

The method 400 proceeds to block 440, with selecting two or more candidate prompts from a set of candidate prompts, such as the initial set. In accordance with one embodiment, the candidate prompts can be selected based on the score associated with the prompt. For example, the two highest-scoring candidate prompts can be selected. Selection based on score allows efficient use of computing resources for further processing of solely high-scoring or high-performing prompts rather than all candidate prompts. For example, the best-performing email writing prompts based on score can be selected for further processing to generate new prompts from the best email writing prompts, as described further below.

The method 400 continues to block 450, with generating additional prompts. The additional prompts can be generated utilizing evolutionary operators such as crossover, mutation, or both. A new generation of candidate prompts can be generated from the selected two or more candidate prompts.

Crossover combines aspects of two candidate prompts to produce a new candidate prompt in a manner similar to how genetic material from both parents contributes to the genetic makeup of the offspring. In one embodiment, a random portion from both parent prompts can be chosen as a crossover point, and the points are swapped between the parent prompts to provide two offspring carrying aspects from both parents. Crossover promotes diversity by mixing prompt aspects, and crossover allows a broad exploration of a prompt space and prevents convergence to a suboptimal prompt. Crossover also reduces the search space by focusing on promising prompts and converges quickly to better prompts by recombining beneficial features.

Mutation can make a minor change to a candidate prompt to produce a new mutated version of the candidate prompt. Mutation plays a significant role in the evolution of candidate prompts analogous to biological mutation. Like crossover, mutation maintains diversity by introducing novelty, which prevents premature convergence by maintaining variability and enables exploration of portions of a solution space to potentially reveal a hidden optimal prompt.

The method 400 continues next to block 460, with scoring the prompts. Block 460 is similar to block 430, but newly generated candidate prompts are scored. Scoring the prompts enables subsequent evaluation of the prompt that can control the production of another generation of candidate prompts or termination.

The method 400 proceeds to block 470, where a decision is made regarding whether or not to terminate. One or more termination criteria can be employed. For example, the termination criterion can be based on execution time, iterations, or other factors. If it is determined that a termination criterion has not been satisfied (“NO”), the method 400 loops back to block 440, where prompts are selected, for example, based on score. If it is determined that a termination criterion has occurred or been satisfied (“YES”), the method 400 proceeds to block 480. In one instance, the decision corresponds to the termination check in an evolutionary computation.

The method 400 continues at block 480, with outputting a prompt. The output prompt can be selected from the set of candidate prompts. In one instance, the highest-scoring prompt can be output. Subsequently, the method 400 terminates.

Note that FIG. 4 is just one example of a method, and other methods including fewer, additional, or alternative steps are possible consistent with this disclosure.

### Example Processing System for Prompt Generation

FIG. 5 depicts an example processing system 500 configured to perform various aspects described herein, including, for example, the method as described above with respect to FIG. 4.

Processing system 500 is generally an example of an electronic device configured to execute computer-executable instructions, such as those derived from compiled or interpreted computer code, including without limitation personal computers, tablet computers, servers, smart phones, smart devices, wearable devices, augmented or virtual reality devices, and others.

In the depicted example, processing system 500 includes one or more processors 502, one or more input/output devices 504, one or more display devices 506, and one or more network interfaces 508 through which processing system 500 is connected to one or more networks (e.g., a local network, an intranet, the Internet, or any other group of processing systems communicatively connected to each other), and computer-readable medium 512.

In the depicted example, the aforementioned components are coupled by a bus 510, which may generally be configured for data or power exchange amongst the components. Bus 510 may be representative of multiple buses, while only one is depicted for simplicity.

Processor(s) 502 are generally configured to retrieve and execute instructions stored in one or more memories, including local memories like the computer-readable medium 512, as well as remote memories and data stores. Similarly, processor(s) 502 are configured to retrieve and store application data residing in local memories like the computer-readable medium 512, as well as remote memories and data stores. More generally, bus 510 is configured to transmit programming instructions and application data among the processor(s) 502, display device(s) 506, network interface(s) 508, and computer-readable medium 512. In certain embodiments, processor(s) 502 are included to be representative of one or more central processing units (CPUs), graphics processing units (GPUs), tensor processing units (TPUs), accelerators, and other processing devices.

Input/output device(s) 504 may include any device, mechanism, system, interactive display, or various other hardware components for communicating information between processing system 500 and a user of processing system 500. For example, input/output device(s) 504 may include input hardware, such as a keyboard, touch screen, button, microphone, or other device for receiving inputs from the user. Input/output device(s) 504 may further include display hardware, such as, for example, a monitor, a video card, or other device for sending or presenting visual data to the user. In certain embodiments, input/output device(s) 504 is or includes a graphical user interface.

Display device(s) 506 may generally include any device configured to display data, information, graphics, user interface elements, and the like to a user. For example, display device(s) 506 may include internal and external displays, such as an internal display of a tablet computer or an external display for a server computer or a projector. Display device(s) 506 may further include displays for devices, such as augmented, virtual, or extended reality devices.

Network interface(s) 508 provide processing system 500 access to external networks and processing systems. Network interface(s) 508 can generally be any device capable of transmitting or receiving data through a wired or wireless network connection. Accordingly, network interface(s) 508 can include a transceiver for sending or receiving wired or wireless communication. For example, network interface(s) 508 may include an antenna, a modem, a LAN port, a Wi-Fi card, a WiMAX card, cellular communications hardware, near-field communication (NFC) hardware, satellite communication hardware, or any wired or wireless hardware for communicating with other networks or devices/systems. In certain embodiments, network interface(s) 508 includes hardware configured to operate in accordance with the Bluetooth® wireless communication protocol.

Computer-readable medium 512 may be a volatile memory, such as a random access memory (RAM), or a non-volatile memory, such as non-volatile random access memory, phase change random access memory, or the like. In this example, computer-readable medium 512 includes initial generation logic 514, score logic 516, selection logic 518, mutation logic 520, and crossover logic 522.

In certain embodiments, the initial generation logic 514 can enable generation of an initial candidate set of prompts based on a plurality of questions and answers. The initial prompt generation component 310 of FIG. 3 can perform the initial generation logic 514.

In certain embodiments, score logic 516 can determine candidate prompt scores based on various prompt features and metrics. The score logic 516 can be performed by the score component 320 of FIG. 3.

In certain embodiments, selection logic 518 can identify and select one or more prompts based on score, for example. The selection logic 518 can select candidate prompts to evolve as well as the final output prompt. The selection component 330 of FIG. 3 can perform the selection logic 518.

In certain embodiments, crossover logic 522 generates a new candidate prompt by combining features of two existing candidate prompts. The crossover component 340 of FIG. 3 can perform the crossover logic 522.

In certain embodiments, mutation logic 520 generates a mutated version of a candidate as an additional candidate prompt. The mutation component 350 of FIG. 3 can perform the mutation logic 520.

Note that FIG. 5 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method of prompt generation, comprising: receiving an initial set of candidate prompts from a large language model in response to a request, generating a score for each candidate prompt in the initial set of candidate prompts, repeating until a termination criterion is satisfied: selecting two or more candidate prompts based on the score, creating additional candidate prompts with the large language model by applying evolutionary operators to the two or more candidate prompts, generating the score for the additional candidate prompts; and evaluating the termination criterion, and outputting one or more candidate prompts based on the score.

Clause 2: The method of Clause 1, further comprising sending the request for the initial set of candidate prompts from the large language model based on two data sets.

Clause 3: The method of Clauses 1-2, wherein the two data sets comprise one or more legitimate questions and one or more illegitimate questions.

Clause 4: The method of Clauses 1-3, wherein the large language model generates the initial set of prompts that respond to the one or more legitimate questions and disapprove the one or more illegitimate questions.

Clause 5: The method of Clauses 1-4, wherein generating the score comprises generating a weighted average of two or more metrics, wherein the two or more metrics capture two or more of prompt execution cost, prompt execution time, similarity of answers, and attack vulnerability.

Clause 6: The method of Clauses 1-5, wherein creating the additional candidate prompts, comprises requesting the large language model perform a mutation operation that changes phrasing of at least one of the two or more candidate prompts.

Clause 7: The method of Clauses 1-6, wherein creating the additional candidate prompts comprises requesting the large language model perform a crossover operation that merges two prompts with a length limitation.

Clause 8: The method of Clauses 1-7, wherein outputting the one or more candidate prompts based on the score comprises submitting a candidate prompt with a highest score to the large language model.

Clause 9: The method of Clauses 1-8, further comprising: receiving the initial set of candidate prompts from a first large language model in response to a request, and creating the additional candidate prompts with a second large language model different from the first large language model.

Clause 10: A processing system, comprising: a memory comprising computer-executable instructions and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium storing program code for causing a processing system to perform the steps of any one of Clauses 1-9.

Clause 13: A computer program product embodied on a computer-readable storage medium comprising code for performing a method in accordance with any one of Clauses 1-9.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from those described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps or actions may be interchanged with one another without departing from the scope of the claims. In other words, unless a specific order of steps or actions is specified, the order or use of specific steps or actions may be modified without departing from the scope of the claims. Further, the various operations of methods described above may be performed by any suitable means capable of performing the corresponding functions. The means may include various hardware or software component(s) or module(s), including, but not limited to a circuit, an application specific integrated circuit (ASIC), or processor. Generally, where operations are illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later become known to those of ordinary skill in the art are expressly incorporated herein by reference and are intended to be encompassed by the claims. Moreover, nothing disclosed herein is intended to be dedicated to the public, regardless of whether such disclosure is explicitly recited in the claims.

What is claimed is:

1. A method of prompt generation, comprising:
receiving an initial set of candidate prompts from a large language model in response to a request;
generating a score for each candidate prompt in the initial set of candidate prompts;
repeating until a termination criterion is satisfied:
selecting two or more candidate prompts based on the score;
creating additional candidate prompts with the large language model by applying evolutionary operators to the two or more candidate prompts;
generating the score for the additional candidate prompts; and
evaluating the termination criterion; and
outputting one or more candidate prompts based on the score.

2. The method of claim 1, further comprising sending the request for the initial set of candidate prompts from the large language model based on two data sets.

3. The method of claim 2, wherein the two data sets comprise one or more legitimate questions and one or more illegitimate questions.

4. The method of claim 3, wherein the large language model generates the initial set of prompts that respond to the one or more legitimate questions and disapprove the one or more illegitimate questions.

5. The method of claim 1, wherein generating the score comprises generating a weighted average of two or more metrics, wherein the two or more metrics capture two or more of prompt execution cost, prompt execution time, similarity of answers, and attack vulnerability.

6. The method of claim 1, wherein creating the additional candidate prompts, comprises requesting the large language model perform a mutation operation that changes phrasing of at least one of the two or more candidate prompts.

7. The method of claim 1, wherein creating the additional candidate prompts comprises requesting the large language model perform a crossover operation that merges two prompts with a length limitation.

8. The method of claim 1, wherein outputting the one or more candidate prompts based on the score comprises submitting a candidate prompt with a highest score to the large language model.

9. The method of claim 1, further comprising:
receiving the initial set of candidate prompts from a first large language model in response to a request; and
creating the additional candidate prompts with a second large language model different from the first large language model.

10. A system, comprising:
at least one processor; and
at least one memory coupled to the at least one processor that stores instructions, that, when executed by the at least one processor, cause the system to:
receive an initial set of candidate prompts from a large language model in response to a request;
generate a score for each candidate prompt in the initial set of candidate prompts;
repeat until a termination criterion is satisfied:
select two or more candidate prompts based on the score;
create additional candidate prompts with the large language model by applying evolutionary operators to the two or more candidate prompts;
generate the score for the additional candidate prompts; and
evaluate the termination criterion; and
outputting one or more candidate prompts based on the score.

11. The system of claim 10, wherein the instructions cause the system to receive the initial set of candidate prompts from the large language model based on two data sets.

12. The system of claim 11, wherein the two data sets comprise one or more legitimate questions and one or more illegitimate questions.

13. The system of claim 12, wherein the large language model generates the initial set of prompts that respond to the one or more legitimate questions and disapprove the one or more illegitimate questions.

14. The system of claim 10, wherein the score is a weighted average of two or more metrics that capture two or more of a cost to execute the prompt, execution time of the prompt, similarity of answers, and attack vulnerability.

15. The system of claim 10, wherein create the additional candidate prompts comprises request the large language model perform a mutation operation that changes phrasing of a prompt.

16. The system of claim 10, wherein create the additional candidate prompts comprises request the large language model perform a crossover operation that merges two prompts with a length limitation.

17. The system of claim 10, wherein output one or more candidate prompts based on the score comprises submit a candidate prompt with a highest score to the large language model.

18. A method, comprising:
submitting a set of one or more legitimate questions and answers and a set of illegitimate questions and a single answer associated with a request to a large language model;
receiving, in response to the request, an initial set of candidate prompts from a large language model that returns a response to the set of legitimate questions and disapproval of the set of illegitimate questions;
generating a score for each candidate prompt in the initial set of candidate prompts;
repeating until a termination criterion is satisfied:
selecting two or more candidate prompts based on the score;
creating additional candidate prompts with the large language model by applying one or more evolutionary operators to the two or more candidate prompts;
generating the score for the additional candidate prompts; and
evaluating the termination criterion; and
outputting one or more candidate prompts based on the score.

19. The method of claim 18, wherein applying the one or more evolutionary operators comprises applying one or more of a mutation operation or a crossover operation on the two or more candidate prompts.

20. The method of claim 18, wherein outputting the one or more candidate prompts based on the score comprises submitting a candidate prompt with a highest score to the large language model.
